(19) United States
(12) Patent Application Publication
(10) Pub. No.: US 2026/0145948 A1
(43) Pub. Date: May 28, 2026

(54) DIAMOND HIGH-PRESSURE INCLUSION AND PREPARATION METHOD THEREOF

(71) Applicant: Center for High Pressure Science and Technology Advanced Research, Beijing (CN)

(72) Inventors: Qiaoshi ZENG, Beijing (CN); Zhidan ZENG, Beijing (CN); Tao LIANG, Beijing (CN); Yong YANG, Beijing (CN); Ho-Kwang MAO, Beijing (CN)

(21) Appl. No.: 19/453,627

(22) Filed: Jan. 20, 2026

Related U.S. Application Data
(63) Continuation of application No. PCT/CN2025/116412, filed on Aug. 22, 2025.

(30) Foreign Application Priority Data
Jun. 24, 2024 (CN) 202410821681.1

(51) Int. Cl. C01B 32/26; B01J 3/06

(52) U.S. Cl. CPC C01B 32/26; B01J 3/065; C01P 2004/04; C01P 2004/12; C01P 2004/20

(57) ABSTRACT

Provided are a diamond high-pressure inclusion and a preparation method thereof. The diamond high-pressure inclusion includes a diamond high-pressure chamber and a solid high-pressure material inside the diamond high-pressure chamber, the high-pressure material being a material under a pressure greater than one atmosphere, and the method includes the following steps: taking a solid target material and at least two layers of a film-shaped carbon material as main raw materials, and subjecting to a high-temperature and high-pressure treatment to obtain the diamond high-pressure inclusion, in which the target material is encapsulated between two adjacent layers of the film-shaped carbon material, and the high-temperature and high-pressure treatment causes the carbon material to transform into the diamond high-pressure chamber which encapsulates the high-pressure material.

### CROSS-REFERENCE TO RELATED APPLICATION

This application is a national stage application of International Patent Application No. PCT/CN 2025/116412, filed on Aug. 22, 2025, which claims the priority of China patent application filed in China National Intellectual Property Administration, on Jun. 24, 2024, with an application number of CN202410821681.1 and an application name of “DIAMOND HIGH-PRESSURE INCLUSION AND PREPARATION METHOD THEREOF”. The disclosure of the two patent applications is incorporated by reference herein.

### TECHNICAL FIELD

The application relates to the technical field of new materials, and relates to a diamond high-pressure inclusion and a preparation method thereof.

### BACKGROUND

Natural diamond high-pressure inclusions come from geological minerals, and is formed by natural diamond capturing inclusion materials under high pressure during the formation of mantle environment and discovered after being carried to the earth's surface. The extremely high strength of diamond makes it possible that inclusions maintain the high pressure of underground environment to a certain extent when they are brought to the earth surface, such that the material structure and properties of high-pressure state can be maintained in the atmospheric environment through inclusions, and thus that it has great research value and application value. However, the types and shapes of natural diamond inclusions can not be controlled artificially, and they are very rare and difficult to obtain.

China Patent Application No. 202210515692.8 discloses a method for preparing high-pressure materials that can be separated from high-pressure devices. This method disclosed that a carbon material and a target material could be mechanically mixed, and then transformed into a diamond high-pressure inclusion at high temperature and high pressure. Although This approach is simple to operate, it often yields non-uniform mixing of the carbon materials and the target materials, resulting in uncontrolled particle distribution and particle size of the high-pressure materials in the obtained inclusion, and incomplete encapsulation of the target materials.

In view of this, this application is provided.

### SUMMARY

The present application provides a diamond high-pressure inclusion and a preparation method thereof, to solve the problems of the existing diamond high-pressure inclusions that the spatial distribution and particle size of high-pressure materials are difficult to control, and the success rate of completely encapsulating the target material is limited.

In the first aspect, the present application provides a method for preparing a diamond high-pressure inclusion, the diamond high-pressure inclusion comprising a diamond high-pressure chamber and a solid high-pressure material inside in the diamond high-pressure chamber, the high-pressure state material comprising a material under a pressure greater than one atmosphere, wherein the method comprises the following steps: taking a solid target material and at least two layers of a film-shaped carbon material as main raw materials, and subjecting to a high-temperature and high-pressure treatment to obtain the diamond high-pressure inclusion, in which the target material is encapsulated between two adjacent layers of the film-shaped carbon material with a certain spatial distribution and/or a certain size, and
the high-temperature and high-pressure treatment causes the carbon material to transform into the diamond high-pressure chamber which encapsulates the high-pressure material.

In the present application, the target material is firstly encapsulated between two adjacent layers of the film-shaped carbon material with a certain spatial distribution and/or a certain size, and this structure as a whole could be donated as a composite film, then the composite film as a main material is subjected to a high-temperature and high-pressure treatment. This method makes it possible to utilize the technical advantages of the film preparation process and the technical characteristics of high-temperature and high-pressure treatment changing carbon into diamond to control the spatial distribution and/or particle size of high-pressure materials in diamond high-pressure inclusions.

The carbon material suitable for the present application includes, but are not limited to, at least one selected from the group consisting of graphite, carbon black, graphene, fullerene, carbon nanotubes, glassy carbon and amorphous carbon.

The target material suitable for the present application includes, but are not limited to, metals, ceramics and semiconductor materials.

According to the method for preparing the diamond high-pressure inclusion provided by the present application, prior to the high-temperature and high-pressure treatment, the target material is completely encapsulated by the film-shaped carbon material, and two adjacent layers of the film-shaped carbon material that encapsulate the target material have no interfacial gap between them.

According to the method for preparing the diamond high-pressure inclusion provided by the present application, the raw materials are prepared by providing the target material on a layer of the film-shaped carbon material, and then providing another layer of the film-shaped carbon material.

The film-shaped carbon material is formed by a film preparation process, and the film preparation process comprises at least one selected from the group consisting of physical vapor deposition, chemical vapor deposition, atomic layer deposition and wet chemical method.

According to the method for preparing the diamond high-pressure inclusion provided by the present application, a composite film composed of two adjacent layers of the film-shaped carbon material and the target material between the two adjacent layers has a total thickness donated as D, which is in a range of 10 nm to 50 μm.

A layer of the film-shaped carbon material has a thickness donated as d, which is not lower than 30%D.

According to the diamond high-pressure inclusion provided by the present application, the target material has a morphology selected from the group consisting of particles, rods and flakes.

Preferably, the target material comprises monodisperse nanoparticles.

According to the method for preparing the diamond high-pressure inclusion provided by the present application, the high-temperature and high-pressure treatment comprises: treating the raw materials at a pressure of 15-100 GPa and a temperature of 1200-2500° C.

According to the method for preparing the diamond high-pressure inclusion provided by the present application, the raw materials are treated at the pressure of 15-100 GPa and the temperature of 1200-2500° C. for 1-20 min.

In the present application, the high-temperature and high-pressure treatment could be performed by a process including, but not limited to, resistance heating, laser heating and other methods that could arrive high temperature.

In the present application, the film-shaped carbon material as one of the raw materials makes it possible to control the structure (phase) and pressure of the diamond high-pressure inclusion by changing the pressure and temperature in the high-temperature and high-pressure treatment.

According to the method for preparing the diamond high-pressure inclusion provided by the present application, the high-temperature and high-pressure treatment is performed by a diamond anvil cell or a large volume press.

According to the method for preparing the diamond high-pressure inclusion provided by the present application, the method comprises the following steps:
forming a first layer of the film-shaped carbon material by a film preparation process,
forming the target material on the first layer of the film-shaped carbon material to obtain a composite layer,
forming a second layer of the film-shaped carbon material on the composite layer by a film preparation process to obtain a composite film, and
stacking one or more layers of the composite film, and then subjecting the stacked composite films to the high-temperature and high-pressure treatment followed by pressure release, to obtain the diamond high-pressure inclusion. Taking one layer of the composite film for example, the process is shown in FIG. 1.

In a second aspect, the present application further provides a diamond high-pressure inclusion, prepared by the method for preparing the diamond high-pressure inclusion.

Preferably, the high-pressure material comprises monodisperse nanoparticles.

The film-shaped carbon materials of two adjacent layers are made by the same material or different materials.

The present application provides a diamond high-pressure inclusion and a preparation method thereof. The diamond high-pressure inclusion includes a diamond high-pressure chamber and a solid high-pressure material inside the diamond high-pressure chamber, the high-pressure material comprises a material under a pressure greater than 1 atmosphere, and the method includes the following steps: taking a solid target material and at least two layers of a film-shaped carbon material as main raw materials, and subjecting to a high-temperature and high-pressure treatment to obtain the diamond high-pressure inclusion, in which the target material is encapsulated between two adjacent layers of the film-shaped carbon material, and the high-temperature and high-pressure treatment causes the carbon material to transform into the diamond high-pressure chamber which encapsulates the high-pressure material. In the present application, a film-shaped carbon material is used as a raw material, the inside pressure of the diamond inclusion, and particle size, volume fraction, spatial distribution state of the encapsulated material could be adjusted according to requirements, thereby realizing highly controllable mass preparation of the diamond high-pressure inclusion composite material.

The method provided by the present application could obtain products across a multi-scale range from nanometers to centimeters, which can meet different applications.

### BRIEF DESCRIPTION OF THE DRAWINGS

In order to illustrate the technical solutions in the present application or the prior art more clearly, the drawings needed in the description of the embodiments or the prior art will be briefly introduced below. Obviously, the drawings in the following description are some embodiments of the present application. For a person ordinary skill in the art, other drawings could be obtained according to these drawings without creative labor.

FIG. 1 is a schematic diagram of the main process for preparing a diamond high-pressure inclusion.

FIG. 2 is a transmission electron microscopy image of a cross section of the carbon-gold-carbon composite film according to Example 2 of the present application.

FIG. 3 is a transmission electron microscopy image of a plane of the carbon-gold-carbon composite film according to Example 2 of the present application.

FIG. 4 shows an electron energy loss spectrum of the carbon layer according to Example 2 of the present application.

FIG. 5 is a high-resolution transmission electron microscopy image of the diamond high-pressure inclusion according to Example 2 of the present application, in which the diamond encapsulates gold nanoparticles in a high-pressure state.

FIG. 6 is a high-resolution transmission electron microscopy image of the diamond high-pressure inclusion according to Example 3 of the present application, in which the diamond encapsulates gold nanoparticles in a high-pressure state.

### DETAILED DESCRIPTION OF THE EMBODIMENTS

In order to make the purpose, technical solutions and advantages of the present application more clear, the technical solutions of the present application will be described clearly and completely with the drawings in the present application. Obviously, the described embodiments are part of the embodiments of the present application, but not all of them. Based on the embodiments in the present application, all other embodiments obtained by a person of ordinary skill in the art without creative labor shall fall within the scope of the present application.

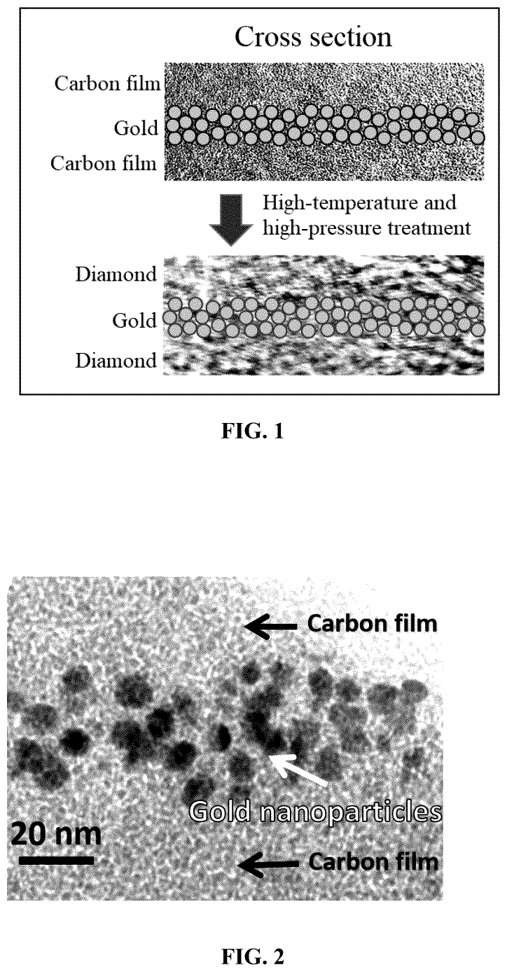

The diamond high-pressure inclusion and the preparation method thereof provided in the present application will be described below with reference to FIGS. 1 to 6.

Technology or conditions that are not specified in the following examples are performed according to those described in literatures in the art or the product specification. Reagents or instruments that are not provided with their manufacturer could be conventional reagents or instruments that could be purchased through regular channels.

Preferred embodiments of the present application as examples will be described in the following.

### Example 1

A method for preparing a diamond high-pressure inclusion was performed by the following steps:
(1) By a magnetron sputtering method, a carbon layer with a thickness of 20 nm was sputtered onto a polyvinyl alcohol hydrogel layer substrate using a carbon target, and the carbon layer was marked as a first carbon layer, wherein the magnetron sputtering method was performed with the following parameters: a radio sputtering power of 200 W, a sputtering time of 2600 seconds, an Ar gas pressure of 20 mTorr, and an Ar gas flow rate of 30 sccm.
(2) By a magnetron sputtering method, gold nanoparticles were sputtered onto the carbon layer obtained in step (1) using a gold target to obtain a composite layer with gold nanoparticles uniformly distributed on a surface thereof, wherein the magnetron sputtering method was performed with the following parameters: a radio sputtering power of 200 W, a sputtering time of 6 seconds, an Ar gas pressure of 20 mTorr, and an Ar gas flow rate of 30 sccm.
(3) By a magnetron sputtering method, another carbon layer, marked as a second carbon layer, was sputtered onto the composite layer obtained in step (2) using a carbon target, to obtain a composite film, wherein the magnetron sputtering method was performed with the following parameters: a radio sputtering power of 200 W, a sputtering time of 2600 seconds, an Ar gas pressure of 20 mTorr, and an Ar gas flow rate of 30 sccm. In part regions of the first carbon layer and the second carbon layer in the composite film, sp² bondings were formed, which kept the gold nanoparticles distributed evenly between the first carbon layer and the second carbon layer; that was, prior to a high-temperature and high-pressure treatment, the first carbon layer and the second carbon layer in the composite film completely encapsulated the gold nanoparticles, and there was no interfacial gap between the first carbon layer and the second carbon layer in the composite film.
(4) The composite film obtained in step (3) was placed in deionized water to dissolve and remove the polyvinyl alcohol hydrogel layer, to obtain a sandwich-like film composed of the first carbon layer, the gold nanoparticles and the second carbon layer, with a total thickness of 60 nm.
(5) 10 layers of the films obtained in step (4) were stacked, naturally dried, and cut into square blocks with a side length of 90 μm. Then the square blocks were put into a diamond anvil cell, and the upper and lower of a press cavity were spread with a layer of sodium chloride as a thermal insulating layer, respectively. The square blocks were pressed to a pressure of 30 GPa, and then laser heated to 1700° C., and held at 1700° C. for 2 min. Finally, the pressure was released to atmospheric pressure, and a diamond inclusion was obtained.

The diamond inclusion obtained in step (5) was analyzed by a transmission electron microscope. The results showed that gold nanoparticles were uniformly distributed in nanocrystalline diamond, and the (111) crystal plane spacing of the gold nanoparticles encapsulated by the diamond was decreased compared with the initial state, indicating that the gold nanoparticles were in a high-pressure state.

### Example 2

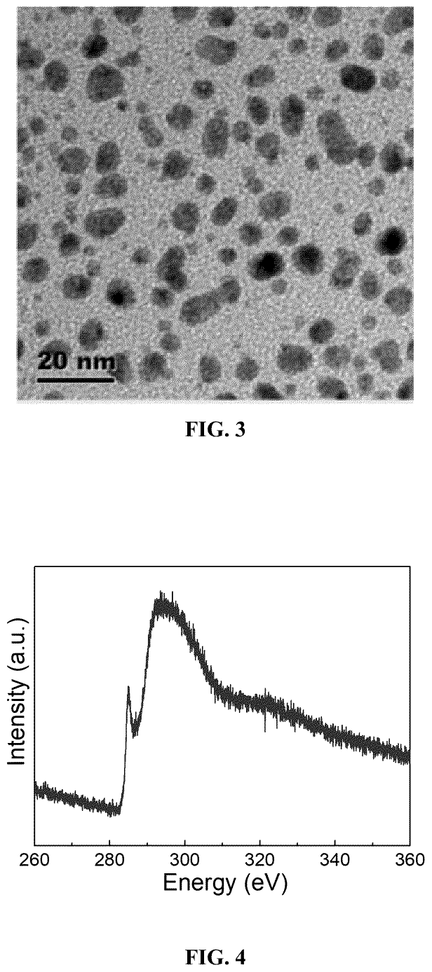

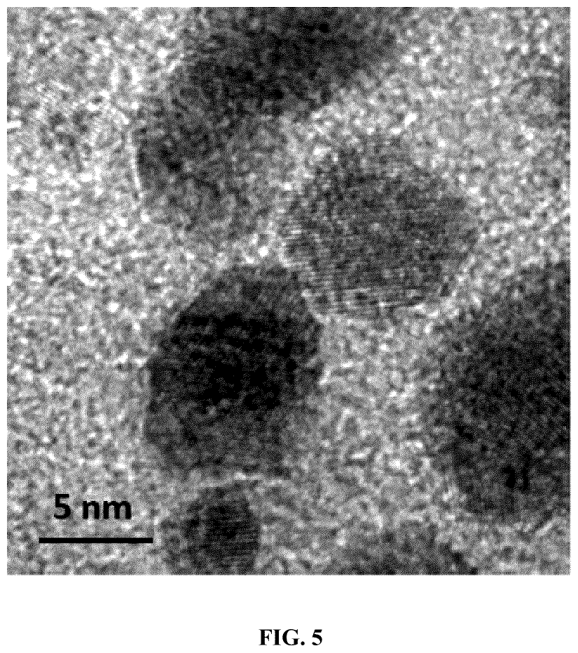

A method for preparing a diamond high-pressure inclusion was performed by the following steps:
(1) By a magnetron sputtering method, a carbon layer with a thickness of 30 nm was sputtered onto a polyvinyl alcohol hydrogel layer substrate using a carbon target, and the carbon layer was marked as a first carbon layer, wherein the magnetron sputtering method was performed with the following parameters: a radio sputtering power of 200 W, a sputtering time of 3900 seconds, an Ar gas pressure of 20 mTorr, and an Ar gas flow rate of 30 sccm.
(2) By a magnetron sputtering method, gold nanoparticles were sputtered onto the carbon layer obtained in step (1) using a gold target to obtain a composite layer with gold nanoparticles uniformly distributed on a surface thereof, wherein the magnetron sputtering method was performed with the following parameters: a radio sputtering power of 200 W, a sputtering time of 9 seconds, an Ar gas pressure of 20 mTorr, and an Ar gas flow rate of 30 sccm.
(3) By a magnetron sputtering method, another carbon layer, marked as a second carbon layer, was sputtered onto the composite layer obtained in step (2) using a carbon target, to obtain a composite film, wherein the magnetron sputtering method was performed with the following parameters: a radio sputtering power of 200 W, a sputtering time of 3900 seconds, an Ar gas pressure of 20 mTorr, and an Ar gas flow rate of 30 sccm. Transmission electron microscopy images of a cross section and a plane of the composite film were shown in FIGS. 2 and 3, and an electron energy loss spectrum of the carbon layer in the film was shown in FIG. 4. It can be seen that sp² bondings were formed in part regions of the first carbon layer and the second carbon layer in the composite film, and the sp² bondings kept the gold nanoparticles distributed evenly between the first carbon layer and the second carbon layer; that was, prior to a high-temperature and high-pressure treatment, the first carbon layer and the second carbon layer in the composite film completely encapsulated the gold nanoparticles, and there was no interfacial gap between the first carbon layer and the second carbon layer in the composite film.
(4) The composite film obtained in step (3) was placed in deionized water to dissolve and remove the polyvinyl alcohol hydrogel layer, to obtain a sandwich-like film composed of the first carbon layer, the gold nanoparticles and the second carbon layer, with a total thickness of 90 nm.
(5) 20 layers of the films obtained in step (4) were stacked, naturally dried, and cut into square blocks with a side length of 90 μm. Then the square blocks were put into a diamond anvil cell, and the upper and lower of a press cavity were charged with Ar as a thermal insulating layer, respectively. The square blocks were pressed to a pressure of 30 GPa, and then laser heated to 1700° C., and held at 1700° C. for 2 min. Finally, the pressure was released to atmospheric pressure, and a diamond inclusion was obtained.

The diamond inclusion obtained in step (5) was analyzed by a transmission electron microscope, and the results were shown in FIG. 5. Gold nanoparticles were uniformly distributed in nanocrystalline diamond. Compared with FIGS. 2 and 3, the distribution and size of the gold nanoparticles encapsulated by the diamond were preserved, and an average (111) crystal plane spacing of the gold nanoparticles was 2.25 Å, indicating that the gold nanoparticles were in a high-pressure state.

### Example 3

A method for preparing a diamond high-pressure inclusion was performed by the following steps:
(1) By a magnetron sputtering method, a carbon layer with a thickness of 30 nm was sputtered onto a polyvinyl alcohol hydrogel layer substrate using a carbon target, and the carbon layer was marked as a first carbon layer, wherein the magnetron sputtering method was performed with the following parameters: a radio sputtering power of 200 W, a sputtering time of 3900 seconds, an Ar gas pressure of 20 mTorr, and an Ar gas flow rate of 30 sccm.
(2) By a magnetron sputtering method, gold nanoparticles were sputtered onto the carbon layer obtained in step (1) using a gold target to obtain a composite layer with gold nanoparticles uniformly distributed on a surface thereof, wherein the magnetron sputtering method was performed with the following parameters: a radio sputtering power of 200 W, a sputtering time of 9 seconds, an Ar gas pressure of 20 mTorr, and an Ar gas flow rate of 30 sccm.
(3) By a magnetron sputtering method, another carbon layer, marked as a second carbon layer, was sputtered onto the composite layer obtained in step (2) using a carbon target, to obtain a composite film, wherein the magnetron sputtering method was performed with the following parameters: a radio sputtering power of 200 W, a sputtering time of 3900 seconds, an Ar gas pressure of 20 mTorr, and an Ar gas flow rate of 30 sccm. In part regions of the first carbon layer and the second carbon layer in the composite film, sp² bondings were formed, which kept the gold nanoparticles distributed evenly between the first carbon layer and the second carbon layer; that was, prior to a high-temperature and high-pressure treatment, the first carbon layer and the second carbon layer in the composite film completely encapsulated the gold nanoparticles, and there was no interfacial gap between the first carbon layer and the second carbon layer in the composite film.
(4) The composite film obtained in step (3) was placed in deionized water to dissolve and remove the polyvinyl alcohol hydrogel layer, to obtain a sandwich-like film composed of the first carbon layer, the gold nanoparticles and the second carbon layer, with a total thickness of 90 nm.
(5) 20 layers of the films obtained in step (4) were stacked, naturally dried, and cut into square blocks with a side length of 60 μm. Then the square blocks were put into a diamond anvil cell, and the upper and lower of a press cavity were charged with Ar as a thermal insulating layer, respectively. The square blocks were pressed to a pressure of 40 GPa, and then laser heated to 1900° C., and held at 1900° C. for 2 min. Finally, the pressure was released to atmospheric pressure, and a diamond inclusion was obtained.

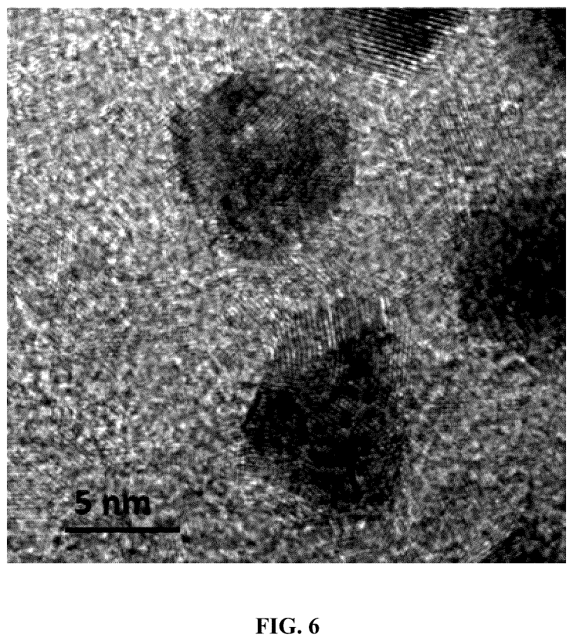

The diamond inclusion obtained in step (5) was analyzed by a transmission electron microscope, and the results were shown in FIG. 6. Gold nanoparticles were uniformly distributed in nanocrystalline diamond, and the gold nanoparticles encapsulated in the diamond had an average (111) crystal plane spacing of 2.23 Å, indicating that the gold nanoparticles were in a high-pressure state, and the pressure was higher than that in Example 2. It can be seen that in the high-temperature and high-pressure treatment, the structure (phase) and pressure could be controlled by changing parameters of pressure and temperature.

Finally, it shall be explained that the above examples are only used to illustrate the technical solutions of the present application, but not to limit it. Although the present application has been described in detail with reference to the foregoing examples, it shall be understood by those skilled in the art that they still can modify the technical solutions described in the foregoing examples or replace some technical features with equivalents. However, these modifications or substitutions do not make the corresponding technical solutions deviate from the conception and scope of the technical solutions of various embodiments of the present application.

What is claimed is:

1. A method for preparing a diamond high-pressure inclusion, the diamond high-pressure inclusion comprising a diamond high-pressure chamber and a solid high-pressure material encapsulated therein, the high-pressure material being a material under a pressure greater than one atmosphere, wherein the method comprises the following steps: taking a solid target material and at least two layers of a film-shaped carbon material as main raw materials, and subjecting to a high-temperature and high-pressure treatment to obtain the diamond high-pressure inclusion, in which the target material is encapsulated between two adjacent layers of the film-shaped carbon material with a certain spatial distribution and/or a certain size, and
the high-temperature and high-pressure treatment causes the carbon material to transform into the diamond high-pressure chamber which encapsulates the high-pressure material.

2. The method for preparing a diamond high-pressure inclusion of claim 1, wherein, prior to the high-temperature and high-pressure treatment, the target material is completely encapsulated by the film-shaped carbon material, and adjacent layers of the film-shaped carbon material that encapsulate the target material have no interfacial gap between them.

3. The method for preparing a diamond high-pressure inclusion of claim 1, wherein the raw materials are prepared by providing the target material on a layer of the film-shaped carbon material, and then providing another layer of the film-shaped carbon material; in which, the film-shaped carbon material is formed by a film preparation process, the film preparation process comprising at least one selected from the group consisting of physical vapor deposition, chemical vapor deposition, atomic layer deposition and wet chemical method.

4. The method for preparing a diamond high-pressure inclusion of claim 1, wherein a composite film composed of two adjacent layers of the film-shaped carbon material and the target material between the two adjacent layers has a total thickness donated as D, which is in a range of 10 nm to 50 μm;
a layer of the film-shaped carbon material has a thickness donated as d, which is not lower than 30%D.

5. The method for preparing a diamond high-pressure inclusion of claim 1, wherein the target material has a morphology selected from the group consisting of particles, rods and flakes.

6. The method for preparing a diamond high-pressure inclusion of claim 1, wherein the high-temperature and high-pressure treatment comprises: treating the raw materials at a pressure of 15-100 GPa and a temperature of 1200-2500° C.

7. The method for preparing a diamond high-pressure inclusion of claim 6, wherein the raw materials are treated at the pressure of 15-100 GPa and the temperature of 1200-2500° C. for 1-20 min.

8. The method for preparing a diamond high-pressure inclusion of claim 1, wherein the high-temperature and high-pressure treatment is performed by a diamond anvil cell or a large volume press.

9. The method for preparing a diamond high-pressure inclusion of claim 1, wherein the method comprises:
forming a first layer of the film-shaped carbon material by a film preparation process,
forming the target material on the first layer of the film-shaped carbon material to obtain a composite layer,
forming a second layer of the film-shaped carbon material on the composite layer by a film preparation process to obtain a composite film, and
stacking one or more layers of the composite film, and then subjecting the stacked composite films to the high-temperature and high-pressure treatment followed by pressure release, to obtain the diamond high-pressure inclusion.

10. A diamond high-pressure inclusion, prepared by the method for preparing a diamond high-pressure inclusion of claim 1.

11. The diamond high-pressure inclusion of claim 10, wherein the high-pressure material comprises monodisperse nanoparticles.

12. The method for preparing a diamond high-pressure inclusion of claim 2, wherein the raw materials are prepared by providing the target material on a layer of the film-shaped carbon material, and then providing another layer of the film-shaped carbon material; in which, the film-shaped carbon material is formed by a film preparation process, the film preparation process comprising at least one selected from the group consisting of physical vapor deposition, chemical vapor deposition, atomic layer deposition and wet chemical method.

13. The method for preparing a diamond high-pressure inclusion of claim 2, wherein a composite film composed of two adjacent layers of the film-shaped carbon material and the target material between the two adjacent layers has a total thickness donated as D, which is in a range of 10 nm to 50 μm;
a layer of the film-shaped carbon material has a thickness donated as d, which is not lower than 30%D.

14. The method for preparing a diamond high-pressure inclusion of claim 5, wherein the target material comprises monodisperse nanoparticles.

15. The method for preparing a diamond high-pressure inclusion of claim 2, wherein the target material has a morphology selected from the group consisting of particles, rods and flakes.

16. The method for preparing a diamond high-pressure inclusion of claim 15, wherein the target material comprises monodisperse nanoparticles.

17. The method for preparing a diamond high-pressure inclusion of claim 2, wherein the high-temperature and high-pressure treatment comprises: treating the raw materials at a pressure of 15-100 GPa and a temperature of 1200-2500° C.

18. The method for preparing a diamond high-pressure inclusion of claim 17, wherein the raw materials are treated at the pressure of 15-100 GPa and the temperature of 1200-2500° C. for 1-20 min.

19. The method for preparing a diamond high-pressure inclusion of claim 2, wherein the high-temperature and high-pressure treatment is performed by a diamond anvil cell or a large volume press.

20. The method for preparing a diamond high-pressure inclusion of claim 2, wherein the method comprises:
forming a first layer of the film-shaped carbon material by a film preparation process,
forming the target material on the first layer of the film-shaped carbon material to obtain a composite layer,
forming a second layer of the film-shaped carbon material on the composite layer by a film preparation process to obtain a composite film, and
stacking one or more layers of the composite film, and then subjecting the stacked composite films to the high-temperature and high-pressure treatment followed by pressure release, to obtain the diamond high-pressure inclusion.
